(19) United States
(12) Patent Application Publication
(10) Pub. No.: US 2008/0170975 A1
(43) Pub. Date: Jul. 17, 2008

(54) Fuel reformer using radiation

(76) Inventors: Jin-goo Ahn, Suwon-si (KR); Ju-yong Kim, Suwon-si (KR); Yong-kul Lee, Suwon-si (KR); Man-seok Han, Suwon-si (KR); Sung-chul Lee, Suwon-si (KR); Jun-sic Kim, Suwon-si (KR); Chan-ho Lee, Suwon-si (KR)

Correspondence Address: ROBERT E. BUSHNELL, 1522 K STREET NW, SUITE 300, WASHINGTON, DC, 20005-1202, US

(21) Appl. No.: 11/896,754

(22) Filed: Sep. 5, 2007

(30) Foreign Application Priority Data
Jan. 12, 2007 (KR) 10-2007-0004000

(51) Int. Cl. B01J 19/02

(52) U.S. Cl. 422/198

(57) ABSTRACT

A fuel reformer using radiation comprises: a reforming reactor including a reforming catalyst for shifting fuel into a desired substance; a heater for supplying heat to the reforming catalyst; and a transparent inner wall positioned between the reforming reactor and the heater. With the present invention, the heat energy of the heater is transferred to the reforming catalyst in a radiation form so that the thermal efficiency of the fuel reformer can be improved.

### CLAIM OF PRIORITY

This application makes reference to, incorporates the same herein, and claims all benefits accruing under 35 U.S.C. §119 from an application for FUEL REFORMER USING RADIATION earlier filed in the Korean Intellectual Property Office on the 12 of Jan. 2007 and there duly assigned Serial No. 2007-4000.

### BACKGROUND OF THE INVENTION

1. Technical Field

The present invention relates to a fuel processor and, more particularly to a high efficient fuel reformer capable of efficiently using radiation of a heater by including a transparent inner wall.

2. Related Art

A fuel processor is an apparatus for shifting fuel into a desired substance, and is commonly called a “fuel reformer”. A fuel reformer for a fuel cell generates hydrogen from a hydrocarbon fuel, and includes a reforming reactor for performing a reforming catalyst reaction in a high temperature and a heater for supplying heat to the reforming reactor. The reforming catalyst reaction is made at about 300° C. in the case of a methanol fuel, and at a high temperature of about 700° C. or more in the case of butane or LPG. As the heater, a catalyst combustor or a burner is used.

In the prior fuel reformer, an inner wall such as a metal wall is generally positioned between the heater and a reforming catalyst in the reforming reactor. In other words, most heat generated from the heater passes through the inner wall, in heat conduction, so as to be transferred to the reforming catalyst. As such, in the fuel reformer, much of the heat of the heater is absorbed into the inner wall, causing problems in that the heat transfer coefficient from the heater to the reforming reactor is lowered, and the durability of the inner wall is deteriorated.

### SUMMARY OF THE INVENTION

The present invention has been developed to solve the problems mentioned above.

It is an object of the present invention to provide a fuel reformer capable of lowering the operating temperature of a heater, preventing the deterioration of durability and improving the heat transfer coefficient, by efficiently transferring radiation generated from the heater to the reforming reactor.

In order to accomplish the above object, according to one aspect of the present invention, a fuel reformer comprises: a reforming reactor including a reforming catalyst for shifting fuel into desired substance; a heater for supplying heat to the reforming catalyst; and a transparent inner wall positioned between the reforming reactor and the heater.

The inner wall is preferably composed of quartz or pyrex.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic perspective view of a fuel reformer according to one embodiment of the present invention;

FIG. 2 is a transverse cross-sectional view of the fuel reformer taken along line II-II as shown in FIG. 1;

FIG. 3 is a schematic perspective view of a fuel reformer according to another embodiment of the present invention; and

FIGS. 4A and 4B are views for comparing the temperature gradient of a fuel reformer of the present invention to the temperature gradient of a fuel reformer of a comparative example.

### DETAILED DESCRIPTION OF THE INVENTION

Hereinafter, preferred embodiments of the present invention, wherein a person having ordinary skill in the art can easily carry out the present invention, will be described in detail with reference to the accompanying drawings.

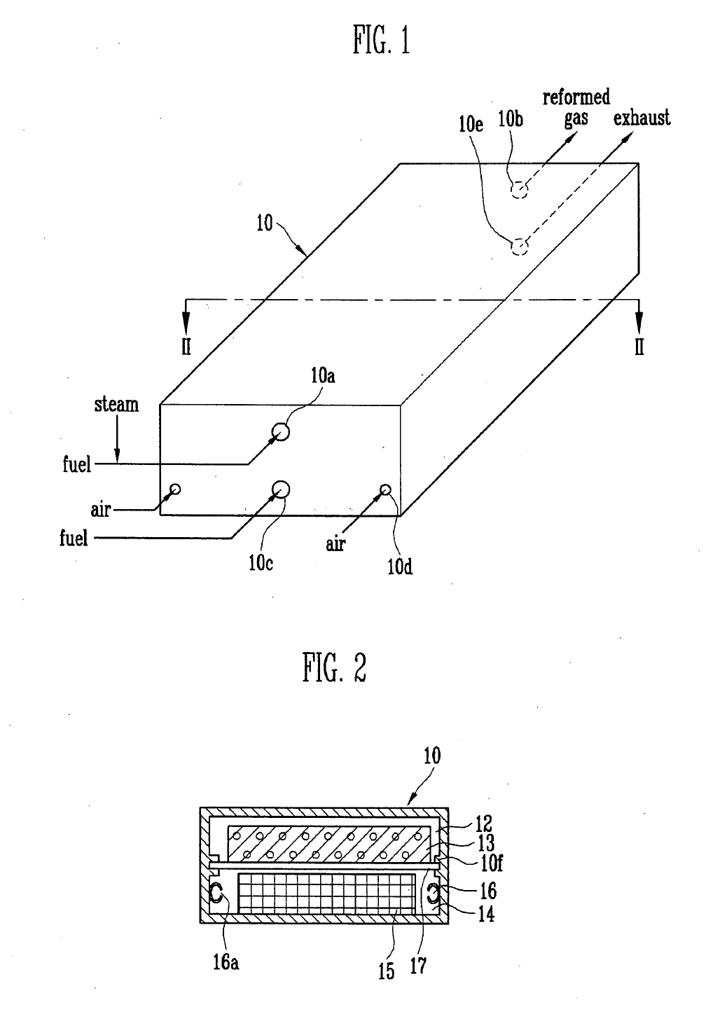

FIG. 1 is a schematic perspective view of a fuel reformer according to one embodiment of the present invention, and FIG. 2 is a transverse cross-sectional view of the fuel reformer taken along line II-II as shown in FIG. 1.

Referring to FIGS. 1 and 2, the fuel reformer 10 of the present invention is an apparatus for reforming hydrocarbon fuel to generate hydrogen gas. The fuel reformer 10 includes a reforming reactor 12 having a reforming catalyst 13 therein. Since the reforming reaction using a catalyst is an endothermic reaction, the reforming reactor 12 needs heat for initiating the reaction. Therefore, the fuel reformer 10 includes a heater 14 for supplying heat to the reforming reactor 12. In particular, the fuel reformer 10 of the present invention includes an inner wall 17 of transparent material positioned between the reforming reactor 12 and the heater 14 in order to improve thermal efficiency.

In the fuel reformer 10, the temperature of a heated body, that is, the reforming catalyst 13 requiring heat, is to be about 300° C. to 700° C., and the temperature of a heating body, that is, the heater 14, is to be higher than the temperature of the reforming catalyst 13 so that heat transfer is accomplished. Most heat transfer in the temperature range is made by means of radiation rather than conduction or convection. According to Stefan-Boltzmanns law, radiation is only in proportion to the difference between the fourth power of the absolute temperatures of the heating body and the heated body without regard to the distance through which heat is transferred. The main wavelength band of the radiation is a red visible rays band so that the radiation passes through the transparent inner wall 17 such as quartz as it is. The present invention improves the thermal efficiency of the fuel reformer by using such a principle.

In the embodiment, the fuel reformer 10 includes a structure wherein the reforming reactor 12 and the heater 14 are separated and disposed into upper and lower layers, putting the inner wall 17 of transparent material therebetween in a single reactor in a generally flat shape. In other words, although the reforming reactor 12 and the heater 14 can be implemented as separate apparatuses, the reforming reactor 12 and the heater 14 as integrally formed will be described in the present embodiment.

The reforming reactor 12 is the unit which performs a steam reforming reaction and/or an auto-thermal reforming reaction. The steam reforming reaction is carried out to convert fuel and sufficient moisture into hydrogen and carbon dioxide by means of a high temperature atmosphere of a catalyst reaction. The reforming reactor 12 includes an inlet hole for the inflow of fuel and steam, and an outlet hole for the outflow of the generated reformed gas.

The reforming reactor 12 has reacting temperatures which are different from each other depending on the fuel intended to be processed. The reacting temperature is approximately in the range of 150° C. to 1200° C. Preferably, in the case of methanol fuel, the temperature at the entrance side of the reforming catalyst 13 is in the range of 150° C. to 200° C., and the temperature of product gas is in the range of 300° C. to 450° C. In the case of butane fuel, the temperature at the entrance side of the reforming catalyst 13 is in the range of 450° C. to 600° C., and the temperature of product gas is in the range of 800° C. to 950° C. As the reforming catalyst 13, a catalyst for steam reforming or a catalyst for autothermal reforming can be used. For example, catalysts of nickel, platinum, copper or ruthenium can be used.

When methanol is used as a fuel, if methanol and water are reacted in the reforming reactor 12 under conditions of constant temperature, hydrogen and carbon dioxide are generated according to an endothermic reaction, as represented by the following Reaction Equation 1:

[Reaction Equation 1]

CH₃OH+H₂O [symbol] CO₂+3H₂

When butane is used as a fuel, if n-butane and water are reacted in the reforming reactor 12 under conditions of constant temperature, hydrogen and carbon dioxide are generated according to an endothermic reaction, as represented by the following Reaction Equation 2:

[Reaction Equation 2]

n-C₄H₁₀+8H₂O [symbol] 4CO₂+13H₂

In the steam reforming reaction using butane, the reforming reaction occurs at a high temperature of about 600° C. to 800° C., and carbon monoxide of about 4% to 10% generally remains in the generated reformed gas by means of heat balance. In Reaction Equation 2, the components of the carbon monoxide generated by the reaction between n-butane and water are omitted.

Meanwhile, the reforming reactor 12 can generate hydrogen by reforming fuel by means of an autothermal reforming reaction. The autothermal reforming reaction of the reforming reactor 12 of the present invention is a composite reaction between the steam reforming reaction and the autothermal reforming reaction, but it is an endothermic reaction where the steam reforming reaction is a main reaction

The autothermal reforming reaction of hydrocarbon is represented by the following Reaction Equation 3:

[Reaction Equation 3]

CₙHₘ+n/2H₂O+n/4 [symbol] nCO₂+(n+m)/2H₂

The heater 14 is the component which generates heat by making combustion fuel, and supplies the generated heat to the reforming reactor 12. The heater 14 includes an inlet hole 10c for the inflow of the fuel for combustion, an air hole 10d for the inflow of air required when making combustion fuel, and an outlet hole 10e for the outflow of the products generated by the combustion of fuel. The heater 14 includes an oxidation catalyst 15 for performing an exothermic reaction, and an air channel 16 for supplying oxygen to the oxidation catalyst 15.

As the oxidation catalyst 15 usable in the heater 14, PdAl₂O₃, NiO, CuO, CeO₂, or Al₂O₃, or material having one or more selected from plutonium (Pu), palladium (Pd) and platinum (Pt) as a main component, can be used.

The air channel 16 is a path for supplying required air at the time of the combustion of fuel by means of the oxidation catalyst 15, and includes a dispensing hole 16a for supplying an appropriate amount of air depending on the flow direction of fuel for combustion.

When butane fuel is used, the butane combustion performing the exothermic reaction in the heater 14 is represented by the following Reaction Equation 4:

[Reaction Equation 4]

n-C₄H₁₀+6.5O₂ [symbol] 4CO₂+5H₂O

The inner wall 17 is formed of transparent material capable of withstanding a high temperature of the environment, and of efficiently transferring the heat energy generated by the heater 14 to the reforming reactor 12. The inner wall 17 is inserted and fixed into a rugged part 10f in the reactor.

The aforementioned inner wall 17 can be implemented by quartz or pyrex having a thickness of 1 mm to 100 mm for its durability and its compactness. Quartz is a silicate mineral formed of silicon dioxide and is used in manufacturing glass, optical instruments, ceramics, etc. Pyrex is glass having a high resistance to thermal shock, chemical durability and a radical change in temperature, and as a representative product, there is pyrex glass. Pyrex glass contains 81% of silicon dioxide (SiO₂) and 12% of boron oxide (B₂O₃), and its thermal expansion coefficient is about ⅓ that of general glass. Also, although the thermal shock resistance of the pyrex does not reach that of quartz, pyrex is more capable of being mass-produced than quartz is, and pyrex has low expansion property with excellent formability.

The fuel reformer 10 according to the present invention is formed to efficiently transfer the heat required in the reforming reaction from the heater 14 to the reforming reactor 12 by using the transparent inner wall 17 in the reactor so that it can lower the operation temperature of the heater 14, and thus can guarantee the durability of the reforming reactor 12 and the heater 14 or the entire reformer for a long time, as compared to fuel reformers of the prior art.

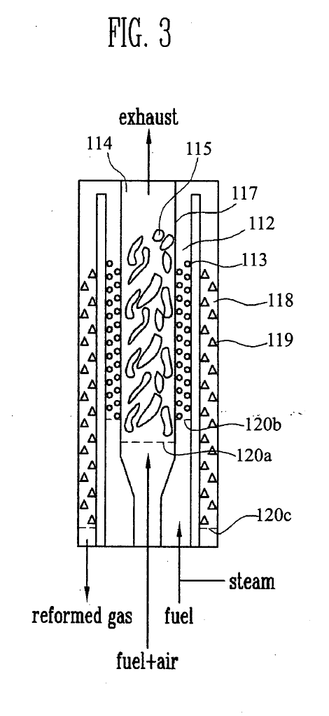

FIG. 3 is a schematic perspective view of a fuel reformer according to another embodiment of the present invention.

Referring to FIG. 3, the fuel reformer of this embodiment of the present invention comprises: a heater 114 including a hollow pipe with an inner wall 117 of transparent material and an oxidation catalyst 115 filled in the inner portion of the hollow pipe; a reforming reactor 112 including an external pipe surrounding the exterior of the heater 114 and a reforming catalyst 113 filled between the external pipe and the heater 114; and a CO removing unit 118 including a channel connected to the reforming reactor 112 and a shift catalyst 119 filled in the channel.

The fuel reformer according to this embodiment has a structure wherein the reforming reactor 112 and the heater 114 are separated and arranged in a dual hollow pipe shape, putting the inner wall 117 of transparent material in a generally cylindrical or tube-type reactor therebetween.

The inner wall 117 can be formed in the entire hollow pipe of the heater 114. On the other hand, the inner wall 117 can be formed in a window shape in a portion thereof. Preferably, the inner wall 117 is formed in many portions of the hollow pipe, if possible, in order to improve the thermal efficiency of the fuel reformer.

Also, the fuel reformer of this embodiment can further include reticular formations 120a, 120b and 120c preventing the dispersion of a reforming catalyst 113 filled in the reforming reactor 112, an oxidation catalyst 115 filled in the heater 114, and a shift catalyst 119 filled in the CO removing unit 118.

The CO removing unit 118 removes carbon monoxide from the reformed gas discharged from the reforming reactor 112. The CO removing unit 118 can be implemented by a water gas shift reactor and/or a preferential CO oxidation (PROX) reactor.

The water gas shift reactor can be implemented by a high temperature of water gas shift reactor and a low temperature of water gas shift reactor. The high temperature of water gas shift reactor primarily reduces carbon monoxide in the reformed gas by reacting fuel and water at about 350° C. to 450° C. As the shift catalyst 119 usable in the high temperature of water gas shift reactor, a high temperature based catalyst, such as Fe₃O₄, Cr₂O₃, etc., usable at temperature of 500° C. or more can be selectively used. The low temperature of water gas reactor further reduces carbon monoxide in the reformed gas by reacting fuel and water at about 200° C. to 250° C. As a shift catalyst usable in the low temperature of water gas shift reactor, a low temperature based catalyst, such as CuO, ZnO, Al2O3, etc., usable at temperature of 200° C. or more, can be selectively used.

The reaction equation for the shifting reaction of the CO removing unit 118 is represented as follows:

[Reaction Equation 5]

CO+H₂O [symbol] CO₂+H₂

The preferential CO oxidation reactor reduces the density of carbon monoxide in the reformed gas by preferentially performing an exothermic reaction on carbon monoxide in the reformed gas and oxygen in the air. If the preferential CO oxidation reactor is used, the density of carbon monoxide in the reformed gas, passing through the reforming reactor or the water gas shift reactor, can be reduced to the desired density, for example, 10 ppm or less. As a catalyst usable in the preferential CO oxidation reactor, there are Ru, Rh, Pt/Al₂O₃, TiO₂, ZrO₂, Au/Fe₂O₃, etc.

In the embodiment, although the heater 114 is described as using the oxidation catalyst 115, the present invention is not limited to such a constitution but is capable of being implemented by a reformer using a burner.

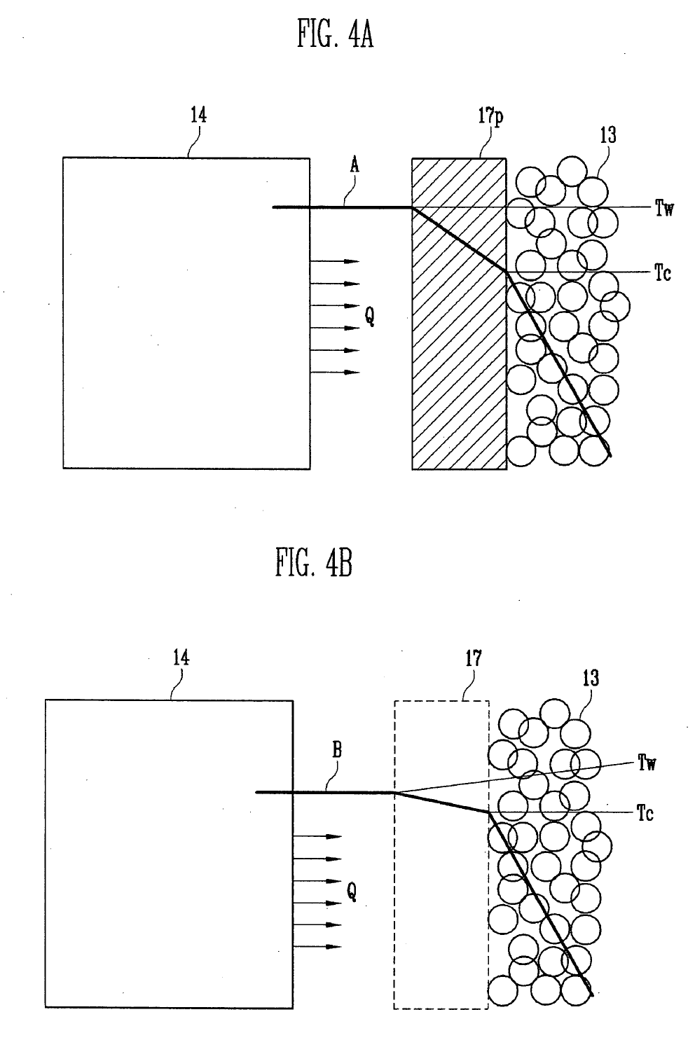

FIGS. 4A and 4B are views for comparing the temperature gradient of a fuel reformer of the present invention to the temperature gradient of a fuel reformer of a comparative example.

In the latter regard, the fuel reformer of the comparative example which includes an opaque inner wall 17p (FIG. 4A) of metal and the fuel reformer of the present invention which includes a transparent inner wall 17 (FIG. 4B) are prepared, and at the time of operation thereof, the temperature gradient from the heater 14 to the reforming catalyst 13 requiring heat is measured.

In the fuel reformer of the comparative example, as can be seen from the temperature gradient curve A shown in FIG. 4A, the heat energy Q generated in the heater 14 is absorbed and refracted to the opaque inner wall 17p, and is conducted through the opaque inner wall 17p so that it is transferred to the reforming catalyst 13 in the reforming reactor. Therefore, it can be appreciated that the temperature gradient of the reactor due to the heat energy Q transferred from the heater 14 to the reforming catalyst 13 represents a great difference between the temperature of the heater 14 or the temperature Tw when reaching the opaque inner wall 17p and the temperature Tc right after passing through the inner wall 17p or the temperature to be maintained for the reaction of the reforming catalyst 13.

To the contrary, in the fuel reformer of the present invention, as be seen from the temperature gradient curve B as shown in FIG. 4B, most heat energy Q generated in the heater 14 passes through the transparent inner wall 17 in an electromagnetic wave form so as to be transferred to the reforming catalyst 13. Therefore, it can be appreciated that the temperature gradient of the reactor due to the heat energy Q transferred from the heater 14 to the reforming catalyst 13 represents a considerably smaller difference between the temperature of the heater 14 or the temperature Tw when reaching the transparent inner wall 17 and the temperature Tc right after passing through the inner wall 17 or the temperature to be maintained for the reaction of the reforming catalyst 13, as compared to the fuel reformer of the comparative example.

As such, the present invention forms the inner wall 17 of the reactor in the fuel reformer with transparent material so that it is advantageous in improving the thermal efficiency of the reactor and in maintaining the durability of the reformer for a long time by lowering the temperature of the heater 14.

As described above, with the present invention, heat can be efficiently transferred from the heater to the reforming catalyst so that the thermal efficiency of the fuel reformer is improved. Furthermore, the operation temperature of the heater can be lowered so that the present invention is effective in guaranteeing the durability of the fuel reformer for a long time.

Although a few embodiments of the present invention have been shown and described, it will be appreciated by those skilled in the art that changes can be made in this embodiment without departing from the principles and spirit of the invention, the scope of which is defined in the claims and their equivalents.

What is claimed is:

1. A fuel reformer, comprising:
a reforming reactor including a reforming catalyst for shifting fuel into a desired substance;
a heater for supplying heat to the reforming catalyst; and
a transparent inner wall positioned between the reforming reactor and the heater.

2. The fuel reformer of claim 1, wherein the inner wall comprises one of quartz and pyrex.

3. The fuel reformer of claim 2, wherein the inner wall has a thickness in a range of 1 mm to 100 mm.

4. The fuel reformer of claim 1, wherein the reforming reactor and the heater are separated by an inner wall in a single reactor.

5. The fuel reformer of claim 1, wherein the reforming reactor and the heater have a dual hollow pipe structure.

6. The fuel reformer of claim 5, wherein an inner portion of the dual hollow pipe structure is filled with an oxidation catalyst.

7. The fuel reformer of claim 5, wherein a reforming catalyst is filled between an external pipe and the heater.

8. The fuel reformer of claim 1, wherein the heater includes an oxidation catalyst for performing an exothermic reaction.

9. The fuel reformer of claim 1, wherein the heater includes a burner for jetting flames.

10. The fuel reformer of claim 1, wherein the reforming catalyst comprises one of a steam reforming catalyst and an autothermal reforming catalyst.

11. The fuel reformer of claim 1, wherein the heater includes an inlet hole for inflow of fuel.

12. The fuel reformer of claim 11, wherein the heater includes an air hole for inflow of air.

13. The fuel reformer of claim 12, wherein the heater includes an outlet hole for outflow of combustion products.

14. The fuel reformer of claim 13, wherein the heater includes an air channel for supplying required air at time of combustion of fuel.

15. The fuel reformer of claim 14, wherein the air channel includes a dispensing hole for supplying an appropriate amount of air depending on flow direction of fuel for combustion.

16. The fuel reformer of claim 1, wherein the heater includes an air hole for inflow of air.

17. The fuel reformer of claim 16, wherein the heater includes an outlet hole for outflow of combustion products.

18. The fuel reformer of claim 17, wherein the heater includes an air channel for supplying required air at time of combustion of fuel.

19. The fuel reformer of claim 1, wherein the heater includes an outlet hole for outflow of combustion products.

20. The fuel reformer of claim 19, wherein the heater includes an air channel for supplying required air at time of combustion of fuel.

21. The fuel reformer of claim 1, wherein the heater includes an air channel for supplying required air at time of combustion of fuel.

22. The fuel reformer of claim 21, wherein the air channel includes a dispensing hole for supplying an appropriate amount of air depending on flow direction of fuel for combustion.

23. A fuel reformer, comprising:
a heater including a hollow pipe for holding an oxidation catalyst;
a reforming reactor including an external pipe surrounding an exterior of the heater, a reforming catalyst being filled between the external pipe and the heater; and
a carbon monoxide removing unit including a channel connected to the reforming reactor, wherein a shift catalyst is filled in the channel.

24. The fuel reformer of claim 23, wherein the heater and the reforming reactor are arranged in a dual hollow pipe shape.

25. The fuel reformer of claim 23, further comprising an inner wall of transparent material.

26. The fuel reformer of claim 25, wherein the inner wall is formed in an entirety of the hollow pipe.

27. The fuel reformer of claim 25, wherein the inner wall is formed in a window shape in a portion of the hollow pipe.

28. The fuel reformer of claim 23, further comprising reticular formations for preventing dispersion of at least one of the oxidation catalyst, the reforming catalyst, and the shift catalyst.

29. The fuel reformer of claim 23, wherein the carbon monoxide removes carbon monoxide from reformed gas discharged from the reforming reactor.

30. The fuel reformer of claim 23, wherein the carbon monoxide removing unit comprises at least one of a water gas shift reactor and a preferential carbon monoxide oxidation reactor.

31. The fuel reformer of claim 30, wherein the water gas shift reactor comprises one of a high temperature gas shift reactor and a low temperature gas shift reactor.
